(19) United States
(12) Patent Application Publication
(10) Pub. No.: US 2014/0089438 A1
(43) Pub. Date: Mar. 27, 2014

(54) METHOD AND DEVICE FOR PROCESSING INFORMATION

(71) Applicant: Huawei Technologies Co., Ltd., Shenzhen (CN)

(72) Inventor: Xiangyu Cui, Hangzhou (CN)

(73) Assignee: Huawei Technologies Co., Ltd., Shenzhen (CN)

(21) Appl. No.: 14/094,134

(22) Filed: Dec. 2, 2013

Related U.S. Application Data
(63) Continuation of application No. PCT/CN2013/072072, filed on Mar. 1, 2013.

(30) Foreign Application Priority Data
Mar. 20, 2012 (CN) 201210074013.4

(51) Int. Cl. H04L 29/08

(52) U.S. Cl. CPC H04L 67/22
USPC 709/206

(57) ABSTRACT

Embodiments of the present invention provide a method and a device for processing information. By obtaining interaction characteristic information corresponding to target information to be sent, according to correspondence between the target information and the interaction characteristic information, matching and obtaining a second user according to the interaction characteristic information, and sending the target information to an information account corresponding to the second user, the embodiments of the present invention can prevent the problem that in the prior art, a network community server can only send related information to a user based on information which the user has browsed, causing that the information obtained by the user is limited, thereby improving universality and accuracy in information acquisition.

### CROSS-REFERENCE TO RELATED APPLICATIONS

This application is a continuation of International Application No. PCT/CN2013/072072, filed on Mar. 1, 2013, which claims priority to Chinese Patent Application No. 201210074013.4, filed on Mar. 20, 2012, both of which are hereby incorporated by reference in their entireties.

### TECHNICAL FIELD

The present invention relates to information processing technologies, and in particular, to a method and a device for processing information.

### BACKGROUND

A network community is an on-line communication space in a form including an electronic bulletin board (Bulletin Board System, BSS for short), a discussion group, a chat room, a blog, or a microblog. A network community server may obtain push characteristic information about a user through analysis based on information the user has browsed, that is, browsing history, and push (send) related information of the same type based on the push characteristic information to the user. In this way, the user obtains and browses information in which the user is interested.

However, since the network community server can only send related information to the user based on the information which the user has browsed, the information obtained by the user is limited, which has a certain limitation, thereby leading to a decrease in universality and accuracy in information acquisition.

### SUMMARY

Embodiments of the present invention provide a method and a device for processing information, so as to improve universality and accuracy in information acquisition.

In one aspect, a method for processing information is provided, including:

determining target information to be sent;

obtaining interaction characteristic information corresponding to the target information according to correspondence between the target information and the interaction characteristic information, where the interaction characteristic information is obtained by collecting personal characteristic information about a first user participating in target information interaction;

matching and obtaining a second user according to the interaction characteristic information; and

sending the target information to an information account corresponding to the second user.

In the other aspect, a device for processing information is provided, including:

a determining unit, configured to determine target information to be sent;

an obtaining unit, configured to obtain interaction characteristic information corresponding to target information according to the correspondence between the target information and the interaction characteristic information, where the interaction characteristic information is obtained by collecting personal characteristic information about a first user participating in target information interaction;

a matching unit, configured to match and obtain a second user according to the interaction characteristic information; and

a sending unit, configured to send the target information to an information account corresponding to the second user.

It can be known from the foregoing technical solutions that, by obtaining the interaction characteristic information corresponding to the target information to be sent, according to the correspondence between the target information and the interaction characteristic information, matching and obtaining the second user according to the interaction characteristic information, and sending the target information to an information account corresponding to the second user, the embodiments of the present invention can prevent the problem that in the prior art that, a network community server can only send related information to a user based on information which the user has browsed, causing that the information obtained by the user is limited, thereby improving universality and accuracy in information acquisition.

### BRIEF DESCRIPTION OF THE DRAWINGS

To illustrate the technical solutions, in the embodiments of the present invention more clearly, the accompanying drawings required for describing the embodiments or the prior art are briefly described in the following. Apparently, the accompanying drawings in the following description merely show some embodiments of the present invention, and persons of ordinary skill in the art may still derive other drawings from these accompanying drawings without creative efforts.

FIG. 1 is a schematic flowchart of a method for processing information according to an embodiment of the present invention;

FIG. 2 is a schematic structural diagram of a device for processing information according to another embodiment of the present invention; and

FIG. 3 is a schematic structural diagram of a device for processing information according to another embodiment of the present invention.

### DETAILED DESCRIPTION

To make the objectives, technical solutions, and advantages of the embodiments of the present invention more clearly, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

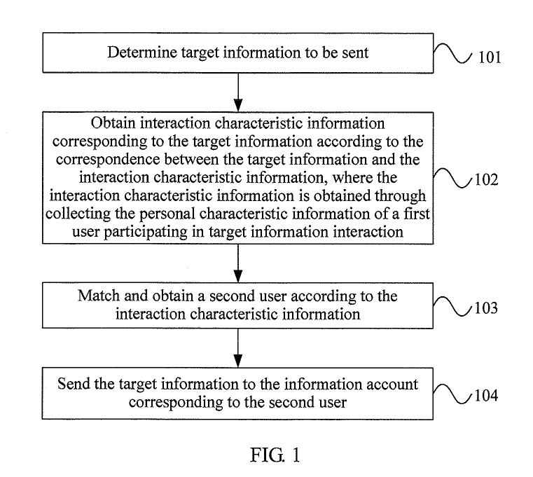

FIG. 1 is a schematic flowchart of a method for processing information according to an embodiment of the present invention. As shown in FIG. 1, the method for processing information according to this embodiment may include:

Step 101: Determine target information to be sent.

The target information may include but is not limited to network community information such as BBS information, discussion group information, chat room information, blog information, or microblog information.

In an optional implementation manner in this embodiment, specifically, the information may be determined as the target information to be sent, according to the user number of first users participating in information interaction. For example, when the number of the first users participating in the information interaction is greater than a preset number threshold, the information may be determined as the target information to be sent.

Step 102: Obtain interaction characteristic information corresponding to the target information according to correspondence between the target information and the interaction characteristic information, where the interaction characteristic information is obtained by collecting personal characteristic information about the first user participating in target information interaction.

The interaction characteristic information may include but is not limited to at least one interaction characteristic value and a probability value corresponding to this interaction characteristic value, which is not limited in this embodiment. For example, an interaction operation may include but is not limited to releasing, commenting, forwarding, saving, and the like, which is not limited in this embodiment.

In an optional implementation manner in this embodiment, before step 102, the personal characteristic information about the first user participating in the target information interaction may be further obtained, the personal characteristic information is sorted, the interaction characteristic information corresponding to the target information is obtained, and the correspondence between the target information and the interaction characteristic information is stored. It should be understood that the personal characteristic information may include but is not limited to at least one among sex, age, academic qualification, graduated college, career, working place, and real-time geographical position.

Step 103: Match and obtain a second user according to the interaction characteristic information.

In an optional implementation manner in this embodiment, a user not participating in the target information interaction is matched by using the interaction characteristic information to obtain a matching degree, where the matching degree may be a function of an interaction characteristic value and a probability value corresponding to this interaction characteristic value, and when the obtained matching degree is greater than a preset matching threshold, a user is determined as the second user.

Step 104: Send the target information to an information account corresponding to the second user.

The subject executing steps 101 to 104 may be a network community server.

In this embodiment, the interaction characteristic information corresponding to the target information to be sent is obtained according to the correspondence between the target information and the interaction characteristic information, and the second user is matched and obtained according to the interaction characteristic information, so that the target information can be sent to the information account corresponding to the second user, which can prevent the problem that in the prior art that, a network community server can only send related information to a user based on information which the user has browsed, causing that the information obtained by the user is limited, thereby improving universality and accuracy in information acquisition.

It should be noted that: for brevity of description, the method embodiments are represented as a series of actions. However, persons skilled in the art should understand that the present invention is not limited to the order of the described actions, because according to the present invention, some steps may adopt other orders or occur simultaneously. It should be further understood by persons skilled in the art that the described embodiments all belong to exemplary embodiments, and the involved actions and modules are not necessarily required by the present invention.

In the embodiments, the description of each embodiment has respective focuses. For a part that is not described in detail in a certain embodiment, reference may be made to related descriptions in other embodiments.

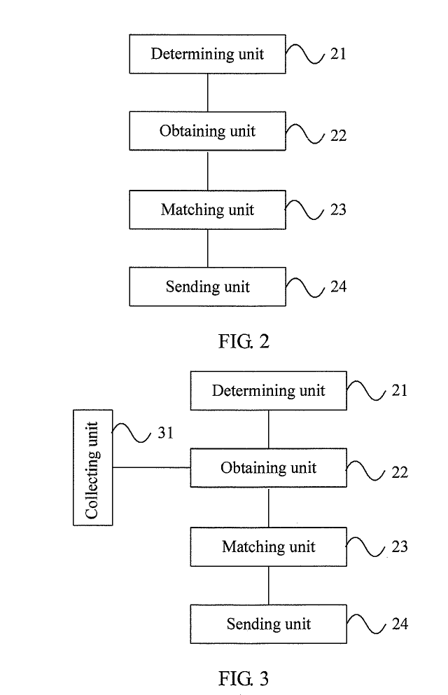

FIG. 2 is a schematic structural diagram of a device for processing information according to another embodiment of the present invention. As shown in FIG. 2, the device for processing information according to this embodiment may include a determining unit 21, an obtaining unit 22, a matching unit 23, and a sending unit 24, where the determining unit 21 is configured to determine target information to be sent; the obtaining unit 22 is configured to obtain interaction characteristic information corresponding to the target information according to correspondence between the target information and the interaction characteristic information, where the interaction characteristic information is obtained by collecting the personal characteristic information about a first user participating in target information interaction; the matching unit 23 is configured to match and obtain a second user according to the interaction characteristic information; and the sending unit 24 is configured to send the target information to an information account corresponding to the second user.

The target information may include but is not limited to network community information such as BBS information, discussion group information, chat room information, blog information, or microblog information.

In an optional implementation manner in this embodiment, the determining unit 21 may specifically determine the information as the target information to be sent, according to the user number of the first users participating in the information interaction. For example, when the user number of the first users participating in the information interaction is greater than a preset number threshold, the determining unit 21 determines the information as the target information to be sent.

The interaction characteristic information may include but is not limited to at least one interaction characteristic value and a probability value corresponding to this interaction characteristic value, which is not limited in this embodiment. For example, an interaction operation may include but is not limited to releasing, commenting, forwarding, saving, and the like, which is not limited in this embodiment.

In an optional embodiment in this embodiment, as shown in FIG. 3, the device for processing information according to this embodiment may further includes a collecting unit 31, configured to:

obtain personal characteristic information about the first user participating in the target information interaction; and

collect the personal characteristic information, obtain the interaction characteristic information corresponding to the target information, and store the correspondence between the target information and the interaction characteristic information, so that the obtaining unit 22 obtains, according to the correspondence, the interaction characteristic information corresponding to the target information determined by the determining unit.

It should be understood that the personal characteristic information may include but is not limited to at least one among sex, age, academic qualification, graduated college, career, working place, and real-time geographical position.

In this embodiment, the obtaining unit obtains the interaction characteristic information corresponding to the target information to be sent, according to the correspondence between the target information and the interaction characteristic information, and the matching unit matches and obtains the second user according to the interaction characteristic information, so that the sending unit can send the target information to the information account corresponding to the second user, which can prevent the problem that in the prior art, a network community server can only send related information to a user based on information which the user has browsed, causing that the information obtained by the user is limited, thereby improving the universality and accuracy in information acquisition.

Persons skilled in the art may clearly understand that, for the purpose of convenient and brief description, for a detailed working process of the foregoing system, apparatus and unit, reference may be made to the corresponding process in the method embodiments, and the details are not described herein again.

In the several embodiments provided in the present invention, it should be understood that the disclosed system, device, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces; and the indirect couplings or communication connections between the apparatuses or units may be implemented in electronic, mechanical or other forms.

The units described as separate parts may or may not be physically separate, and parts displayed as units may or may not be physical units, may be located in one position, or may be distributed on a plurality of network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit. The integrated unit may be implemented through hardware, or may also be implemented in a form of hardware plus a software functional unit.

The integrated unit implemented in the form of software functional unit may be stored in a computer readable storage medium. The software functional unit is stored in a storage medium, and includes several instructions used to instruct a computer device (for example, a personal computer, a server, or a network device) to perform part of the steps of the methods according to the embodiments of the present invention. The storage medium includes: any medium that is capable of storing program codes, such as a USB flash disk, a removable hard disk, a read-only memory (Read-Only memory, ROM for short), a random access memory (Random Access Memory, RAM for short), a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solution of the embodiments of the present invention.

What is claimed is:

1. A method for processing information, the method comprising:
determining target information to be sent;
obtaining interaction characteristic information corresponding to the target information according to correspondence between the target information and the interaction characteristic information, wherein the interaction characteristic information is obtained by collecting personal characteristic information about a first user participating in target information interaction;
matching and obtaining a second user according to the interaction characteristic information; and
sending the target information to an information account corresponding to the second user.

2. The method according to claim 1, wherein determining target information to be sent comprises:
determining information as the target information to be sent, according to the user number of the first users participating in information interaction.

3. The method according to claim 1, before obtaining interaction characteristic information corresponding to the target information according to correspondence between the target information and the interaction characteristic information, further comprising:
obtaining the personal characteristic information about the first user participating in the target information interaction; and
collecting the personal characteristic information, obtaining the interaction characteristic information corresponding to the target information, and storing the correspondence between the target information and the interaction characteristic information.

4. The method according to claim 2, before obtaining interaction characteristic information corresponding to the target information according to correspondence between the target information and the interaction characteristic information, further comprising:
obtaining the personal characteristic information about the first user participating in the target information interaction; and
collecting the personal characteristic information, obtaining the interaction characteristic information corresponding to the target information, and storing the correspondence between the target information and the interaction characteristic information.

5. The method according to claim 1, wherein the interaction characteristic information comprises at least one interaction characteristic value and a probability value corresponding to the interaction characteristic value.

6. A device for processing information, the device comprising:
a determining unit, configured to determine target information to be sent;
an obtaining unit, configured to obtain interaction characteristic information corresponding to the target information according to correspondence between the target information and the interaction characteristic information, wherein the interaction characteristic information is obtained by collecting personal characteristic information about a first user participating in target information interaction;
a matching unit, configured to match and obtain a second user according to the interaction characteristic information; and
a sending unit, configured to send the target information to an information account corresponding to the second user.

7. The device according to claim 6, wherein the determining unit is configured to:
determine information as the target information to be sent, according to the user number of the first users participating in information interaction.

8. The device according to claim 6, wherein the device further comprises a collecting unit, configured to:
obtain the personal characteristic information about the first user participating in the target information interaction; and
collect the personal characteristic information, obtain the interaction characteristic information corresponding to the target information, and store the correspondence between the target information and the interaction characteristic information.

9. The device according to claim 7, wherein the device further comprises a collecting unit, configured to:
obtain the personal characteristic information about the first user participating in the target information interaction; and
collect the personal characteristic information, obtain the interaction characteristic information corresponding to the target information, and store the correspondence between the target information and the interaction characteristic information.

10. The device according to claim 6, wherein the interaction characteristic information comprises at least one interaction characteristic value and a probability value corresponding to the interaction characteristic value.

11. The device according to claim 7, wherein the interaction characteristic information comprises at least one interaction characteristic value and a probability value corresponding to the interaction characteristic value.

12. The device according to claim 8, wherein the interaction characteristic information comprises at least one interaction characteristic value and a probability value corresponding to the interaction characteristic value.
